(19) United States
(12) Patent Application Publication
(10) Pub. No.: US 2025/0202322 A1
(43) Pub. Date: Jun. 19, 2025

(54) DEVICE ASSEMBLY WITH A CONTROLLER FOR CONDITION MONITORING

(71) Applicant: Dematic Corp., Grand Rapids, MI (US)

(72) Inventor: Benjamin S. Thomas, Wyoming, MI (US)

(21) Appl. No.: 18/543,374

(22) Filed: Dec. 18, 2023

(51) Int. Cl. H02K 11/35; H02H 7/08; H02K 11/25; H02K 11/27; H02K 11/33

(52) U.S. Cl. CPC H02K 11/35; H02H 7/0822; H02H 7/0844; H02K 11/25; H02K 11/27; H02K 11/33; H02K 2211/03

(57) ABSTRACT

A device assembly has one or more controllers that improve monitoring the condition of a device so that risks to the device are reduced. A controller of the device assembly calculates a state estimate of a device for a given time by performing a state estimation calculation based on data from a measuring instrument coupled to the device. The state estimate improves monitoring whether the device is at risk so that the controller can more accurately trigger the device to modify operation before failure, damage, and/or malfunctions of the device occurs. A controller of the device assembly more effectively monitors the condition of the device by merging data from one or more measuring instruments coupled to the device, and performing any state estimation calculation, such as to calculate a state of health estimate. The controller and measuring instrument are included in a system-in-package.

### TECHNICAL FIELD AND BACKGROUND

The present disclosure relates to condition monitoring, and, more particularly, to a device assembly with a controller for condition monitoring.

Condition monitoring is the process of monitoring conditions of devices, and is used to ensure such devices continue to operate under normal conditions. The conditions of devices are monitored by monitoring any measurements of such devices such as, for example, vibrations, pressure, electrical signals, and temperature of devices. For instance, the temperature of devices may be monitored to prevent such devices from overheating, which can be caused by a variety of reasons including lack of maintenance, electrical problems, environmental factors, overloading, etc. Overheating may cause device damage, failure, and/or malfunctions. Many devices are at risk of overheating such as, for example, motors, transformers, and generators. Regardless of the type of device, the temperature of the device may be monitored to prevent device damage, failure, and/or malfunctions.

### SUMMARY

This disclosure provides a device assembly having one or more controllers that improve the performance of a device by more accurately monitoring the condition (i.e., state) of the device. For example, the device assembly has a temperature measurement controller to more accurately trigger the device to shut down or adjust operation when the device is at risk of overheating at given times, which prevents failure, damage, and/or malfunctions of such device. The temperature measurement controller triggers the device to modify operation (e.g., to shut down) based on a temperature state estimate that more accurately indicates whether the device is at risk of overheating at given times, which is calculated by the temperature measurement controller performing one or more state estimation calculations based on temperature data of the device.

In another example, the device assembly has a fusion controller that merges data from one or more measuring instruments of the device to more effectively monitor whether the device is operating at abnormal conditions that may damage such device. Further, the fusion controller performs any state estimation calculation to calculate any state of estimate, such as to calculate a state of health estimate.

In one form of the present disclosure, a device assembly includes a device and a measuring instrument coupled to the device to generate data. The device assembly includes a controller that calculates a state estimate of the device for a given time by performing a state estimation calculation based on the data.

In one aspect, the controller determines if the device is at risk at the time based on the state estimate. If the controller determines the device is at risk, the controller generates a fault signal to trigger the device to modify operation.

In another aspect, the device modifies operation by shutting down.

In yet another aspect, the measuring instrument is a temperature measuring instrument that generates temperature data. The device assembly also has a current measuring instrument that generates current data, and is coupled to the device. The controller performs the state estimation calculation based on both the temperature data and the current data.

In yet another aspect, the device is a motor, and the current measuring instrument generates the current data based on current input into the motor.

In yet another aspect, the device has a printed circuit board (PCB), and the measuring instrument is coupled to the PCB.

In yet another aspect, the controller determines whether the device is at risk by determining whether the state estimate exceeds a predetermined threshold state estimate. The device is at risk when the controller determines the state estimate exceeds the threshold state estimate.

In yet another aspect, the controller performs the state estimation based on the previous state estimate.

In yet another aspect, the controller performs the state estimation calculation by using a Kalman Filter.

In yet another aspect, the state estimate is a state of health estimate.

In yet another aspect, the controller merges data.

In yet another aspect, the controller merges the data by performing a state estimation calculation using a Kalman Filter.

In yet another aspect, the device assembly has a system-in-package including the one or more measuring instruments and the controller.

In another form of the present disclosure, a device assembly has a device, a plurality of measuring instruments that generate data, a fusion controller that merges the data, a temperature measurement controller, and a device controller. The temperature measurement controller performs a state estimation calculation based on the merged data to calculate a state estimate of the device for a time. The temperature measurement controller determines whether the device is at risk at the time based on the state estimate, and generates a fault signal in response to determining the device is at risk. The device controller triggers the device to modify operation in response to determining the device is at risk.

In one aspect, the device assembly has a system-in-package that includes the plurality of measuring instruments, the fusion controller, the temperature measurement controller, and the device controller.

In yet another form of the present disclosure, a device assembly includes a device and a temperature measuring instrument coupled to the device to generate temperature data. The device assembly includes a controller that has estimation logic to calculate a state estimate of the device for a given time by performing a state estimation calculation based on the temperature data. The controller has fault logic to determine if the device is at risk of overheating at the time based on the state estimate. If the controller determines the device is at risk of overheating, the controller generates a fault signal to trigger the device to modify operation.

In one aspect, the device assembly includes a current measuring instrument coupled to the device to generate current data. The controller performs the state estimation calculation based on the current data to calculate the state estimate of the device for the given time.

In another aspect, the device is a motor, and the current measuring instrument generates the current data based on current input into the motor.

In yet another aspect, the device has a printed circuit board that is coupled to the temperature measuring instrument.

In yet another aspect, the fault logic determines whether the device is at risk of overheating at the given time based on the state estimate by determining whether the state estimate exceeds a predetermined threshold state estimate. The device is at risk of overheating when the fault logic determines the state estimate exceeds the threshold state estimate.

In yet another aspect, the device modifies operation by shutting down.

In yet another aspect, the estimation logic performs the state estimation calculation by using a Kalman Filter.

In yet another aspect, the estimation logic uses both a predict measurement equation and an update measurement equation based on the Kalman Filter.

In yet another aspect, the controller initializes the estimation logic.

In yet another aspect, the controller determines parameters for the estimation logic.

In yet another aspect, the controller updates the parameters.

In yet another aspect, the fault logic generates a continue signal to instruct the device to continue operation when the fault logic determines the device is not at risk of overheating.

In yet another aspect, the device assembly has another device coupled to another temperature measuring instrument.

In yet another aspect, the device assembly has a fusion controller and a plurality of measuring instruments coupled to the device.

In yet another aspect, the device assembly has a device controller. The fusion controller generates a fault signal based on data generated by one or more of the measuring instruments from the plurality of measuring instruments. The device controller triggers the device to modify operation in response to receiving a fault signal from the fusion controller and/or the temperature measurement controller.

In yet another aspect, the device assembly has a system-in-package including the temperature measurement controller, the plurality of measuring instruments, the fusion controller, and the device controller.

In yet another aspect, the device assembly has a system-in-package including a carrier substrate. The temperature measurement controller, the plurality of measuring instruments, the fusion controller, and the device controller are mounted on the carrier substrate.

In yet another aspect, the fusion controller merges data generated by one or more of the measuring instruments from the plurality of measuring instruments to produce merged data.

In yet another aspect, the temperature measurement controller performs another state estimation calculation based on the merged data to calculate a state estimate of the device.

In yet another aspect, the fusion controller performs a state estimation calculation based on data produced by one or more of the measuring instruments to calculate a state estimate of the device.

In yet another aspect, the fusion controller merges the data generated by one or more measuring instruments from the plurality of measuring instruments by using a Kalman Filter.

In yet another aspect, the fusion controller performs a state estimation calculation to calculate a state estimate.

In yet another aspect, the state estimate is a state of health estimate of the device.

In yet another aspect, the fusion controller performs the state estimation calculation by using a Kalman Filter.

Thus, the device assembly more accurately monitors the condition of the device so that failure, damage, and/or malfunctions of the device are prevented. The device assembly has a temperature measurement controller to more accurately trigger the device to shut down or adjust operation before overheating occurs. This is accomplished by the temperature measurement controller triggering the device to shut down or adjust operation based on one or more temperature state estimates that more accurately indicate whether the device is at risk of overheating at given times. These temperature state estimates are calculated by the temperature measurement controller performing one or more state estimation calculations based on temperature data of the device. Additionally, the device assembly has a fusion controller to more effectively monitor the condition of the device by merging data from one or more measuring instruments associated with device, and performing any state estimation calculation to calculate any state estimate, such as to calculate a state of health estimate.

These and other objects, advantages, purposes, and features of this disclosure will become apparent upon review of the following specification in conjunction with the drawings.

### BRIEF DESCRIPTION OF DRAWINGS

FIG. 1 is a perspective view of a device assembly having a temperature measurement controller and a motor;

FIG. 2 is a block diagram of a device assembly having a temperature measurement controller that may be the temperature measurement controller of FIG. 1;

FIG. 3 is a block diagram of a device assembly having one or more devices, an initial parameter determiner, and a temperature measurement controller that may be the temperature measurement controller of FIG. 1; and

FIG. 4 is a block diagram of a device assembly having an one or more measuring instruments, a fusion controller, a device controller, and a temperature measurement controller that may be the temperature measurement controller of FIG. 1.

FIG. 5 is a flowchart representative of a process for determining whether the one or more devices of FIG. 3 are at risk of overheating.

### DESCRIPTION OF THE PREFERRED EMBODIMENTS

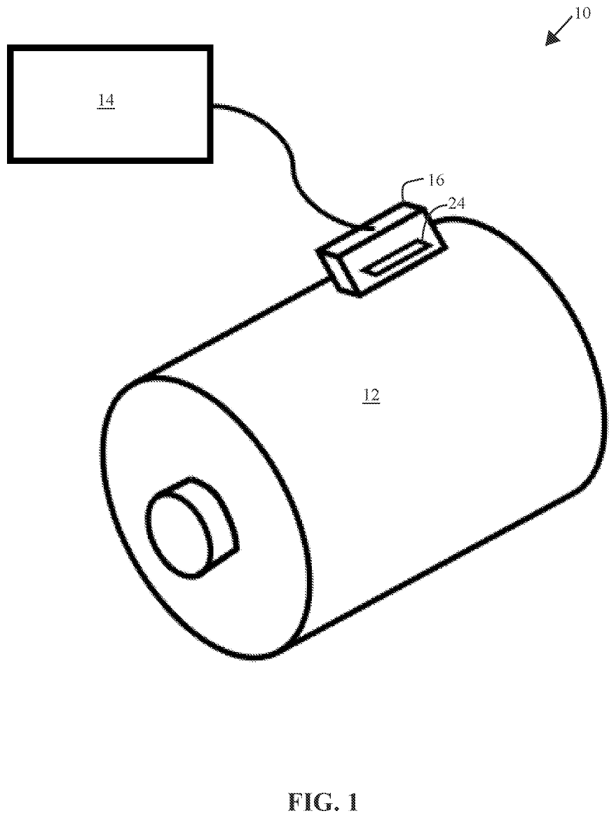

Referring now to the drawings and illustrative embodiments depicted therein, a device assembly 10 has one or more devices that change conditions during operation, such as a motor 12, a transformer, and/or a generator. (FIG. 1). The condition of the device may be monitored by the device assembly 10 for detecting abnormal conditions that create a risk to the device (e.g., a risk of fault, risk of damage, risk of overheating) so that the device assembly 10 can modify operation of the device to prevent such risks. Additionally or alternatively, the device assembly 10 may communicate conditions to an end user of the device (e.g., an operator of a vehicle including the device) so that the end user is informed about the conditions of such device. The condition of the device may be monitored by one or more measurement controllers of the device assembly 10 by monitoring data produced by one or more measuring instruments (e.g., sensors) associated with such devices. As used herein, the term “data” is to be interpreted broadly and is meant to encompass any information in any suitable format. Additionally, the term “condition” and “state” may be used interchangeably herein.

In one embodiment, the temperature of a device is measured to protect the device from overheating that can cause failure, damage, and/or malfunctions of the device. The temperature of the device may be measured by one or more measuring instruments that are coupled to the device. The one or more measuring instruments may include a temperature sensor, a thermal sensor, a thermal camera, an environmental sensor, and/or any other sensor capable of detecting overheating conditions. Temperature measuring instruments may generate temperature data (e.g., temperature measurement signals) obtained by a temperature measurement controller 14 of the device assembly 10 so that the temperature measurement controller 14 can monitor whether the device is at risk of overheating.

If the temperature measurement controller 14 determines the device is at risk of overheating based on the temperature data, the temperature measurement controller 14 triggers the device to modify operation, such as stopping operation (i.e., to shut down) or adjusting operation such that overheating of the device is prevented. However, the temperature measurement controller 14 may not accurately trigger the device to stop or adjust operation solely based on the temperature data because the temperature data may be generated by a common temperature measuring instrument (e.g., thermistor, thermocouple) that has a low time constant such that the temperature measuring instrument does not respond quickly to temperature changes. Therefore, the common temperature measuring instrument may not generate temperature data that accurately reflects rapidly changing temperatures of the device. The temperature measurement controller 14 more accurately monitors the state of the device by more accurately determining whether the device is at risk of overheating, even if the temperature is rapidly increasing.

As described in further detail below, the temperature measurement controller 14 improves determining whether the device is at risk of overheating by performing one or more state estimation calculations based on temperature data of the device to calculate a temperature state estimate indicative of whether the device is at a risk of overheating at a given time. This temperature state estimate allows the temperature measurement controller 14 to more quickly and accurately trigger the device to shut down or adjust operation, compared to the controller 14 relying on solely temperature data without state estimation calculations, which improves the performance of the device by preventing failure, damage and/or malfunctions of such device. The temperature measurement controller 14 may perform any state estimation calculation based on any estimation technique that improves predicting when the device will be at risk of overheating such as, for example, a Moving Horizon Estimation algorithm, a Least Squares Method, and/or a Kalman Filter.

Referring to FIG. 1, the temperature measurement controller 14 is included in the device assembly 10 to monitor the motor 12 that is controlled by a motor controller 16. The motor controller 16 may cause the motor 12 to shut down if the temperature measurement controller 14 determines that the motor 12 or the motor controller 16 presents a risk in the device assembly 10, such as a risk of damage to the device assembly 10 due to a rapid increase in temperature within the device assembly 10. The rapid increase in temperature may be caused by an increase in current intensity, such as an increase in current input into the motor 12. Although a temperature measuring instrument coupled to the motor 12 and/or the motor controller 16 may generate temperature data so that the temperature measurement controller 14 can determine changes in temperature, the temperature measuring instruments that are commonly integrated into the device assembly 10 (e.g., thermistors, thermocouples) due to their relative cheapness and ease of integration with the device assembly 10 may not generate temperature data that accurately reflects rapidly changing temperatures, as discussed previously.

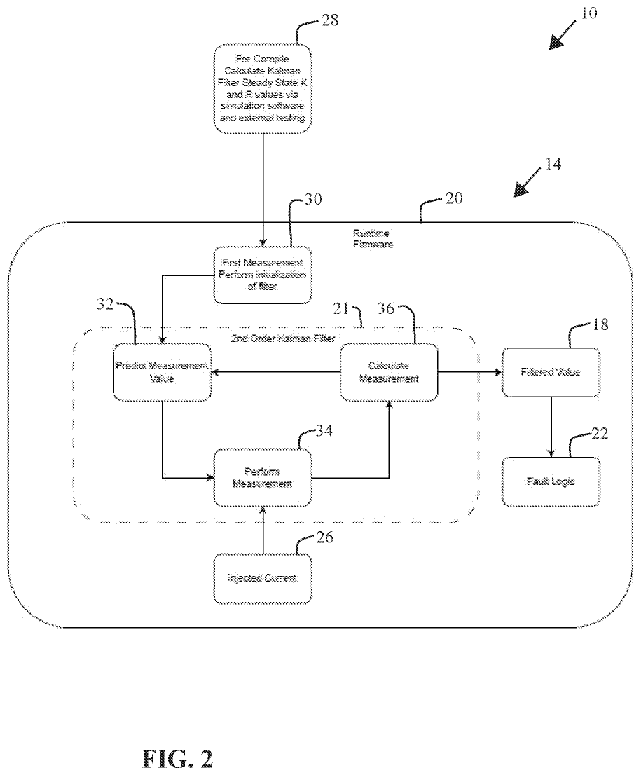

The temperature measurement controller 14 improves determining whether the motor 12 and/or the motor controller 16 is at risk of overheating at a given time, even if the temperature is rapidly increasing, by having estimation logic that performs one or more state estimation calculations based on temperature data to calculate a filtered value 18, which is a temperature state estimate shown in FIG. 2. (FIGS. 1-2). The filtered value 18 more accurately indicates whether there is a risk of overheating at a given time compared to determining whether there is a risk based on solely temperature data without implementing estimation logic. The temperature measurement controller 14 may also calculate the filtered value 18 based on current data if the temperature of the device assembly 10 is affected by current input into the motor 12. If the temperature measurement controller 14 determines that the filtered value 18 indicates a risk of overheating at the given time, the temperature measurement controller 14 more accurately triggers the motor 12 to shut down. The temperature measurement controller 14 may trigger the motor 12 to shut down by generating a fault signal for the motor controller 16 so that the motor controller 16 can cause the motor 12 to shut down before the motor 12 and/or motor controller 16 is/are damaged.

Referring to FIG. 2, the temperature measurement controller 14 may have firmware 20 that has estimation logic to execute an estimation algorithm, such as a second order Kalman Filter 21, during runtime to calculate the filtered value 18 that is a temperature state estimate indicating whether the device assembly 10 is at risk of overheating at a given time. The filtered value 18 may be an input to fault logic 22 of the firmware 20. The fault logic 22 determines whether the device assembly 10 is at risk of overheating such as, for example, by determining whether the filtered value 18 exceeds a predetermined threshold state estimate that indicates a risk of failure.

In one example, the filtered value 18 is an input to the fault logic 22 that determines whether the printed circuit board (PCB) 24 located in the motor controller 16 (as shown in FIG. 1) or in the motor 12 (not shown) is at risk of overheating at a given time, and the fault logic 22 sends a fault signal to the motor controller 16 if the fault logic 22 determines that the PCB 24 is at risk so that the motor controller 16 can trigger the motor 12 to shut down.

In another example, the filtered value 18 is an input to the fault logic 22 that determines whether the temperature of the motor 12 is rapidly increasing such that the motor 12 is at risk of degradation at a given time, and the fault logic 22 sends a fault signal to the motor controller 16 if the fault logic 22 determines that the motor 12 is at risk so that the motor controller 16 can trigger the motor 12 to shut down.

As discussed previously, the filtered value 18 more accurately indicates whether there is a risk of overheating because the firmware 20 calculates the filtered value 18 (i.e., temperature state estimate) by implementing estimation logic that uses the Kalman Filter 21, which includes performing one or more state estimation calculations. The Kalman Filter 21 is a recursive estimation algorithm such that the instant state estimate (e.g., filtered value 18 for tₖ) is calculated based on the previous state estimate (e.g., filtered value 18 for tₖ₋₁). For example, assuming the Kalman Filter 21 previously produced the filtered value 18 two times (i.e., filtered value 18 for a first time that indicates whether the device is at risk of overheating at t₁, and filtered value 18 for a second time that indicates whether the device is at risk of overheating at t₂), the Kalman Filter 21 calculates the filtered value 18 for a third time (i.e., t₃) based on the filtered value 18 of t₂ and not based on the filtered value 18 of t₁.

The Kalman Filter 21 has an input of temperature data from one or more temperature measuring instruments of the device assembly 10. For example, the temperature data may be generated by a temperature sensor, such as a thermistor or thermocouple, that is both coupled to the motor 12 and communicatively coupled to the firmware 20 so that the firmware 20 obtains the temperature data of the motor 12.

In another example, a temperature sensor is both coupled to the PCB 24 and communicatively coupled to the firmware 20 so that the firmware 20 obtains temperature data of the PCB 24. The temperature data allows the Kalman Filter 21 to produce a filtered value 18 (e.g., filtered value 18 for a third time t₃) that indicates whether there is a risk of overheating based on an increase in temperature of the device assembly 10, which is determined based on both the temperature data and the previously calculated filtered value 18 (e.g., filtered value 18 for a second time t₂).

As discussed previously, the temperature of the device assembly 10 may be affected by current injected 26 (e.g., current input) into the motor 12 such that an increase in current intensity may indicate that the temperature of the device assembly 10 is increasing. Current data that measures the current injected 26 into the motor 12 may be an input to the Kalman Filter 21 because the current data may indicate whether the temperature of the device assembly 10 is increasing before the temperature data, which is due to the low time constant of common temperature measuring instruments, as discussed previously. The current data may be generated by one or more current measuring instruments that are both coupled to the motor 12 and communicatively coupled to the firmware 20 so that the firmware 20 obtains current data that indicates the amount of current injected 26 into the motor 12. For example, a current measuring instrument may be a current sensor resistor that measures the difference of voltage between both sides of the resistor, and then the values are used to calculate the current data by using Ohm's Law or a Differential Operational Amplifier.

The current data and temperature data may be inputs to Kalman Filter equations associated with the estimation logic of the Kalman Filter 21 so that the firmware 20 can perform one or more state estimation calculations based on the Kalman Filter 21 to calculate the filtered value 18. The Kalman Filter equations have parameters that are compiled before runtime (e.g., pre-compile via simulation software and external testing) by one or more devices that may be implemented by hardware, software, firmware and/or any combination of hardware, software, and/or firmware. (block 28 of FIG. 2). The parameters may include steady state parameters such as a Kalman gain (“K”) and matrices (“R”). Alternatively, one or more of the parameters may be updated by the firmware 20 during runtime such as, for example, based on error covariances of the Kalman Filter 21. When the firmware 20 receives temperature data for the first time (i.e., initial temperature data), the firmware 20 initializes the Kalman Filter 21 based on the parameters pre-compiled at block 28 and the initial temperature data. (block 30 of FIG. 2). As discussed previously, the Kalman Filter 21 is a recursive estimation algorithm such that the instant filtered value 18 is calculated based on the previous filtered value 18. Therefore, to calculate the filtered value 18 for the first time (i.e., indicating whether the device is at risk of overheating at t₁), the initialization of the Kalman Filter 21 at block 30 may include the firmware 20 calculating an initial filtered value so that the firmware 20 can calculate the filtered value 18 by using the initial filtered value as the previous filtered value 18 because the firmware 20 has not previously calculated a filtered value 18.

As shown in FIG. 2, the Kalman Filter 21 begins by the firmware 20 using one or more Kalman Filter equations to predict a measurement value for a given time (i.e., tₖ), which is an estimate of the filtered value 18 for tₖ before inputting the current data and the temperature data into the Kalman Filter 21. (block 32). If no filtered value 18 has been produced by the Kalman Filter 21, the firmware 20 predicts the measurement value for tₖ based on the initial filtered value calculated at block 30. (block 32). If a filtered value 18 has been produced by the Kalman Filter 21, the firmware 20 predicts the measurement value for tₖ based on the previously calculated filtered value 18 (i.e., filtered value 18 for tₖ₋₁). (block 32). The firmware 20 then performs measurements of the current data indicating the amount of current injected 26 into the motor 12 and the temperature data from the device assembly 10. (block 34). The firmware 20 uses the predicted measurement value for tₖ (block 32), the performed measurements (block 34), and one or more Kalman Filter equations to calculate the filtered value 18 for tₖ that indicates whether the device assembly 10 is at risk of overheating at tₖ, as discussed previously. (block 36).

The Kalman Filter equations used while calculating the filtered value 18 may include a predict measurement equation, which predicts a temperature state estimate at a given time (i.e., tₖ) as shown in Equation 1:

$${\hat{x}}_{k}^{-} = A {\hat{x}}_{k - 1} + {Bu}_{k - 1} \qquad Equation 1$$

In Equation 1, \hat{x}ₖ⁻ denotes a predicted state estimate at tₖ (e.g., predicted temperature state estimate), \hat{x}ₖ₋₁ denotes a previous state estimate at tₖ₋₁ (e.g., the filtered value 18 of tₖ₋₁ calculated at block 36, or the initial filtered value calculated at block 30 if no filtered value 18 has been previously calculated by using the Kalman Filter 21), uₖ₋₁ denotes a control input (e.g., the current data from current injected 26 into the motor 12 measured at block 34), A relates the state at tₖ₋₁ to the state at tₖ (e.g., one of the matrices (“R”) pre-compiled at block 28), and B relates the control input u to the state x (e.g., one of the matrices included in the matrices (“R”) pre-compiled at block 28). The firmware 20 may use Equation 1 to predict the measurement value for tₖ at block 32 by calculating A\hat{x}ₖ₋₁ in Equation 1, which is a prediction of the filtered value 18 before considering the current data (e.g., uₖ₋₁) and the temperature data.

The Kalman Filter equations used while calculating the filtered value 18 may also include an update measurement equation, which updates the predicted temperature state estimate at a given time (i.e., tₖ) calculated in Equation 1, as shown in Equation 2:

$${\hat{x}}_{k} = {\hat{x}}_{k}^{-} + K ( {z}_{k} - H {\hat{x}}_{k}^{-} ) \qquad Equation 2$$

In Equation 2, \hat{x}ₖ denotes a corrected state estimate at tₖ (e.g., the filtered value 18 of tₖ calculated at block 36), \hat{x}ₖ⁻ denotes the predicted state estimate at tₖ calculated in the Equation 1, K is the Kalman gain (e.g., the Kalman gain (“K”) pre-compiled at block 28), zₖ is a measurement (e.g., temperature data measured from the device assembly 10 at block 34), and H relates the state to measurement zₖ (e.g., one of the matrices (“R”) pre-compiled at block 28). The firmware 20 may use Equation 1 and Equation 2 to calculate the filtered value 18 (e.g., \hat{x}ₖ) at block 36 by calculating the predicted temperature state estimate for tₖ (e.g., \hat{x}ₖ⁻=A\hat{x}ₖ₋₁+Buₖ₋₁) and then the filtered value 18 for tₖ (e.g., \hat{x}ₖ=\hat{x}ₖ⁻+K(zₖ−H\hat{x}ₖ⁻)). (block 36).

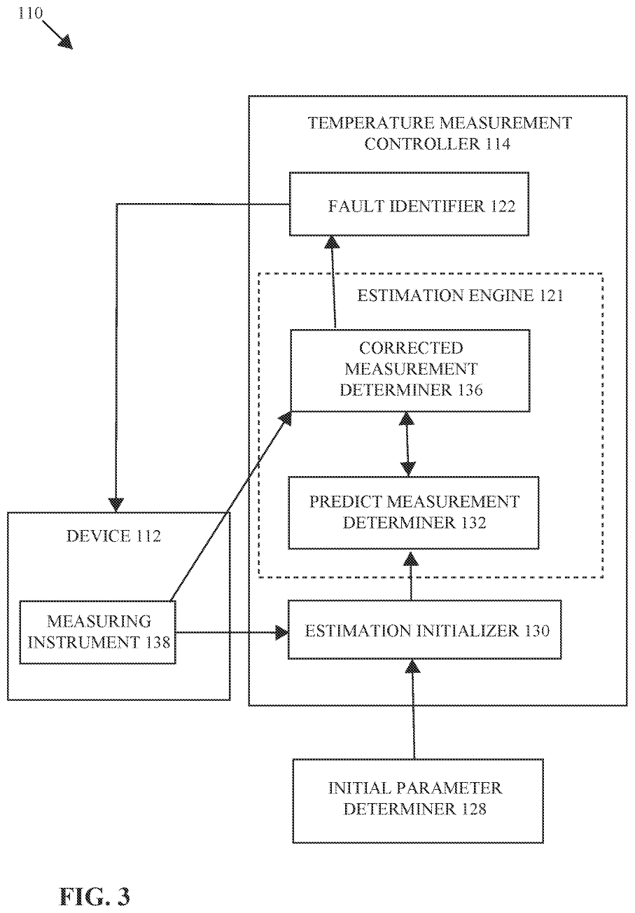

Referring to FIG. 3, the device assembly 110 has a temperature measurement controller 114 that is communicatively coupled to one or more devices 112 (e.g., a motor, a transformer, and/or a generator) to monitor whether the one or more devices 112 are at risk of overheating at given times. In one example, the temperature measurement controller 114 may be implemented as a separate component that interfaces or is otherwise in communication with the device 112 (e.g., an existing device) similar to the temperature measurement controller 14 shown in FIGS. 1 and 2. In other examples, the temperature measurement controller 114 may be partially or fully implemented as part of the device 112. The temperature measurement controller 114 has a fault identifier 122 (e.g., fault logic 22 of FIG. 2) to determine whether the device 112 is at risk of overheating at a given time.

If the fault identifier 122 determines that the device 112 is at risk of overheating, the fault identifier 122 triggers the device 112 to stop operation or adjust operation such that damage, failure, and/or malfunctions of the device 112 is prevented. For example, the device 112 may trigger the power supply of the device 112 to shut down. Alternatively, the device 112 may trigger a fan of the device 112 to begin operation for a period of time such that the airflow cools the device 112. In another example, device 112 may trigger a reduction, rather than complete disconnection, of current input into the device 112 for a period of time. The fault identifier 122 may instruct the device 112 to continue operation if the device 112 is not at risk of overheating (e.g., send a continue signal to the device 112).

The fault identifier 122 determines whether the device 112 is at risk of overheating based on a temperature state estimate obtained from an estimation engine 121 of the temperature measurement controller 114. The estimation engine 121 may implement estimation logic that uses any estimation algorithm to perform one or more state estimation calculations to improve the temperature state estimate of the device 112 for a given time such as, for example, a Kalman Filter (e.g., the Kalman Filter 21 of FIG. 2), a Moving Horizon Estimation algorithm, and/or a Least Squares Method. The estimation logic has one or more data inputs from one or more measuring instruments 138 of the device 112. The measuring instruments 138 may include one or more temperature measuring instruments such as, for example, a temperature sensor (e.g., a thermistor or thermocouple), a thermal sensor, a thermal camera, an environmental sensor, or any other sensor capable of detecting overheating conditions. The measuring instruments 138 may also include one or more current measuring instruments if current input into the device 112 influences the temperature of the device 112, as discussed previously. However, if the temperature of the device 112 is not affected by current input into the device 112, the device 112 may not have any current measuring instruments.

In some examples, the estimation logic of the estimation engine 121 performs state estimation calculations based on equations that have parameters. These parameters are calculated by an initial parameter determiner 128 that is communicatively coupled to the temperature measurement controller 114, and the initial parameter determiner 128 may perform operations similar to block 28 of FIG. 2. The initial parameter determiner 128 may be implemented as a separate component that interfaces or is otherwise in communication with the temperature measurement controller 114, as shown in FIG. 3. In other examples, the initial parameter determiner 128 may be partially or fully implemented as part of the temperature measurement controller 114 and/or the device 112.

The temperature measurement controller 114 may have an estimation initializer 130 to initialize the estimation logic of the estimation engine 121 based on the parameters calculated by the initial parameter determiner 128 and input data from one or more of the measuring instruments 138, and the estimation initializer 130 may perform calculations similar to block 30 of FIG. 2. A predict measurement determiner 132 of the estimation engine 121 may calculate a predict measurement value based on the estimation logic and a previous temperature state estimate calculated by the estimation initializer 130 or a corrected measurement determiner 136 of the estimation engine 121, and the predict measurement determiner 132 may perform calculations similar to block 32 of FIG. 2.

The corrected measurement determiner 136 may calculate the temperature state estimate for a given time based on the estimation logic, the predict measurement value calculated by the predict measurement determiner 132, and input data from one or more of the measuring instruments 138. The corrected measurement determiner 136 may obtain data similar to block 34 and perform calculations similar to block 36 of FIG. 2. The corrected measurement determiner 136 may send the temperature state estimate to the fault identifier 122 so that the fault identifier 122 can determine whether the device 112 is at risk of overheating at the given time, as discussed previously.

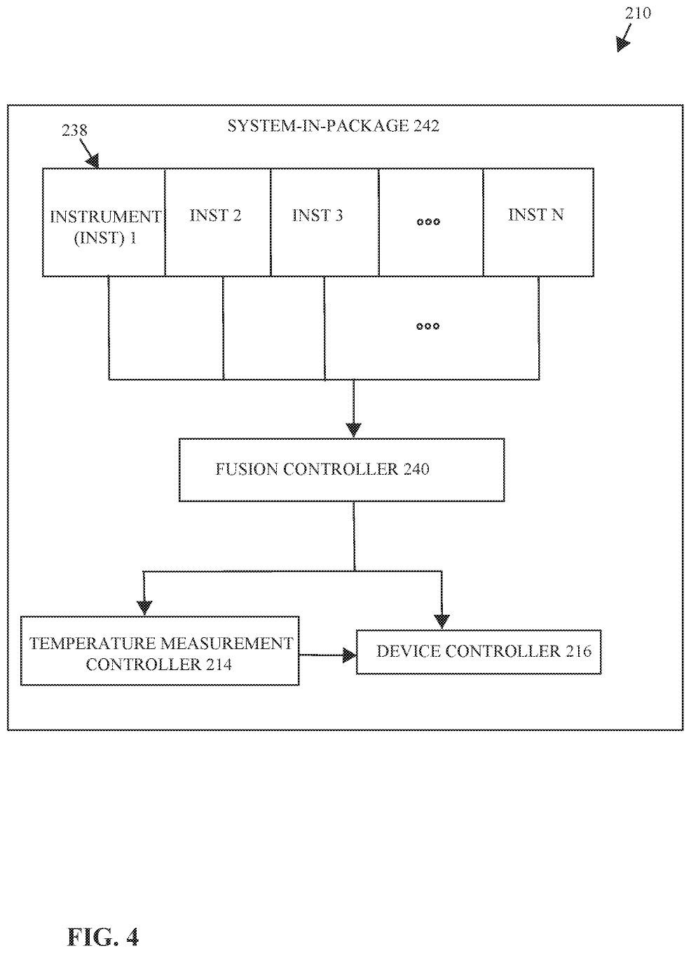

Referring to FIG. 4, the device assembly 210 has a fusion controller 240 that monitors the state of a device (e.g., motor 12, device 112) based on data generated by one or more measuring instruments 238 (e.g., the one or more measuring instruments 138 of FIG. 3). The one or more measuring instruments 238 include one or more temperature sensor(s) (e.g., thermistor, thermocouple), thermal sensor(s), thermal camera(s), environmental sensor(s), current sensor(s) (e.g., current sensor resistor) and/or any other device(s) capable of detecting abnormal conditions (e.g., overheating) of devices. In one example, the one or more measuring instruments 238 are a sensor array.

The fusion controller 240 may combine or merge measurements from a set of the one or more measuring instruments 238 to produce merged data. For example, the fusion controller 240 may merge first data generated by a first measuring instrument 238 and second data generated by a second measuring instrument 238. In another example, the fusion controller 240 may merge two measurements generated by one measuring instrument 238. The merged data allows the fusion controller 240 to more effectively monitor whether the device is operating at abnormal conditions that may damage such device.

Measurements generated by measuring instruments 238 may transfer between the measuring instruments 238 prior to the combination of such measurements by the fusion controller 240. For example, a first measuring instrument 238 generates first data that is transmitted to a second measuring instrument 238. Such second measuring instrument 238 generates second data, and the second measuring instrument 238 transfers both the first data and second data to the fusion controller 240 for producing the merged data.

The measurements generated by the one or more measuring instruments 238 may be combined by the fusion controller 240 using an estimation algorithm, such as a Kalman Filter previously discussed, to produce merged data. In another example, the fusion controller 240 includes a summing mixer that combines the measurements to produce the merged data.

The merged data produced by the fusion controller 240 may be transmitted to the temperature measurement controller 214 so that the temperature measurement controller 214 can use the merged data to determine whether a device (e.g., motor 12, device 112) is at risk of overheating at given times similar to the temperature measurement controller 114 of FIG. 3. Similar to the device controller 16 of FIG. 1, the device controller 216 of FIG. 4 may trigger a device to adjust or modify operation if the temperature measurement controller 214 determines the device is at risk (e.g., risk of fault, risk of damage, risk of overheating) at a given time.

The fusion controller 240 may use one or more estimation algorithms, such as a Kalman Filter previously discussed, to perform any state estimation calculation. The state estimation calculation may be performed to produce a state estimate that indicates any condition of a device (e.g., motor 12, device 112). In one example, a state estimate is a state of health estimate of the motor 12. The state estimation calculation may be performed based on data generated by a set of the one or more measuring instruments 238. For example, the merged data produced by the fusion controller 240 may be used to perform a state estimation calculation.

The fusion controller 240 may send a fault signal to the device controller 216 if the fusion controller 240 determines the device is operating at an abnormal condition and/or at risk based on data generated by a set of the one or more measuring instruments 238, the merged data, and/or the state estimate(s) so that the device controller 216 can trigger the device to shut down or modify operation. Additionally or alternatively, the data generated by a set of the one or more measuring instruments 238, the merged data, and/or the state estimate(s) may be communicated to an end user of a device (e.g., an operator of a vehicle including the motor 12).

The one or more measuring instruments 238, the fusion controller 240, the temperature measurement controller 214, and/or the device controller 216 may be included in a system-in-package (SiP) 242 as shown in FIG. 4. For example, the one or more measuring instruments 238, the fusion controller 240, the temperature measurement controller 214, and the device controller 216 may be mounted on a carrier substrate and integrated into a single package to form the SiP configuration.

While example implementations of the device assembly 10, 110, 210 are shown in FIGS. 1-4, one or more of the elements, processes and/or devices illustrated in FIGS. 1-4 may be combined, divided, re-arranged, omitted, eliminated and/or implemented in any other way. For example, the initial parameter determiner 128, the estimation initializer 130, the predict measurement determiner 132, and/or the corrected measurement determiner 136 of FIG. 3 may be replaced with one or more of elements, processes and/or devices if the estimation engine 121 does not implement the Kalman Filter 21 of FIG. 2. In another example, the estimation engine 121 of FIG. 3 may have one or more additional elements, processes and/or devices if one or more parameters (e.g., Kalman gain (“K”) and matrices (“R”)) are updated while executing the estimation engine 121.

Further, the one or more devices 112, the temperature measurement controller 114, 214, the device controller 216, the estimation engine 121, the fault identifier 122, the initial parameter generator 128, the estimation initializer 130, the predict measurement determiner 132, the corrected measurement determiner 136, the one or more measuring instruments 138, 238, and the fusion controller 240, shown in FIGS. 3-4 may be implemented by hardware, software, firmware and/or any combination of hardware, software, and/or firmware. Thus, for example, the one or more devices 112, the temperature measurement controller 114, 214, the device controller 216, the estimation engine 121, the fault identifier 122, the initial parameter generator 128, the estimation initializer 130, the predict measurement determiner 132, the corrected measurement determiner 136, the one or more measuring instruments 138, 238, and/or the fusion controller 240 shown in FIGS. 3-4 could be implemented by one or more analog or digital circuit(s), logic circuit(s), programmable processor(s), graphics processing unit(s) (GPU(s)), digital signal processor(s) (DSP(s)), application specific integrated circuit(s) (ASIC(s)), programmable logic device(s) (PLD(s)), field programmable logic device(s) (FPLD(s)), multi-core processor(s), electronic control unit(s), and/or crypto processor(s).

When reading any of the apparatus or system claims of this patent to cover a purely software and/or firmware implementation, at least one of the one or more devices 112, the temperature measurement controller 114, 214, the device controller 216, the estimation engine 121, the fault identifier 122, the initial parameter generator 128, the estimation initializer 130, the predict measurement determiner 132, the corrected measurement determiner 136, the one or more measuring instruments 138, 238, and/or the fusion controller 240 shown in FIGS. 3-4 is/are hereby expressly defined to include a non-transitory computer readable storage device or storage disk such as a memory, a digital versatile disk (DVD), a compact disk (CD), a Blu-ray disk, etc. including the software and/or firmware.

Further still, the one or more devices 112, the temperature measurement controller 114, 214, the device controller 216, the estimation engine 121, the fault identifier 122, the initial parameter generator 128, the estimation initializer 130, the predict measurement determiner 132, the corrected measurement determiner 136, the one or more measuring instruments 138, 238, and the fusion controller 240 shown in FIGS. 3-4 may include one or more elements, processes and/or devices in addition to, or instead of, those illustrated in FIGS. 3-4, and/or may include more than one of any or all of the illustrated elements, processes, and devices.

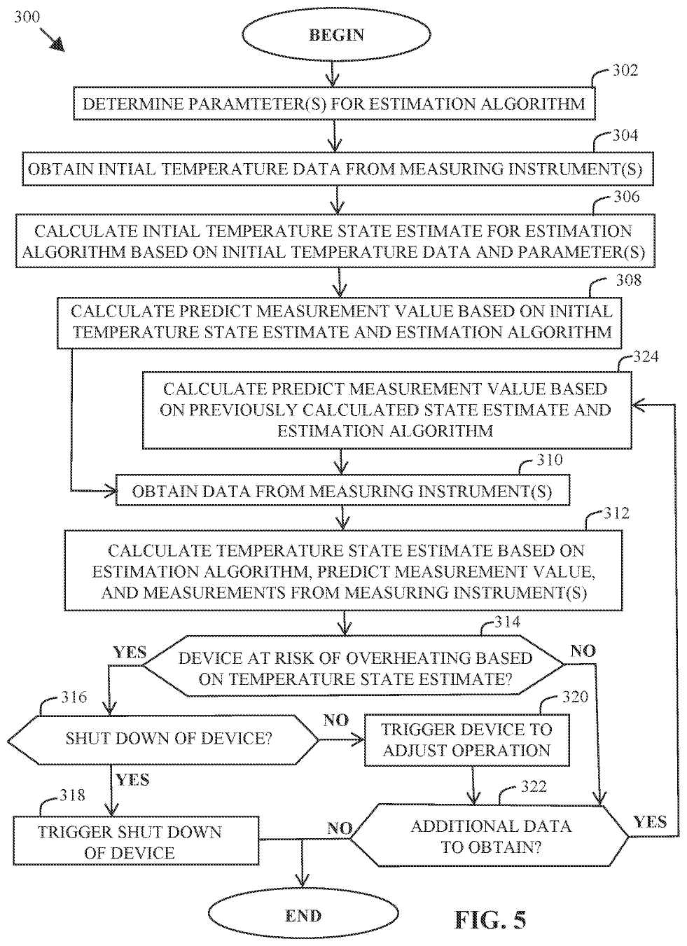

FIG. 5 is a flowchart representative of an example process 300 that implements the temperature measurement controller 114 and/or the initial parameter determiner 128 of FIG. 3 to determine whether the device 112 is at risk of overheating. The process 300 may be implemented as hardware logic, machine readable instructions, hardware implemented state machines, and/or any combination thereof. At block 302, the process 300 begins when the initial parameter determiner 128 determines one or more parameters for the estimation algorithm (e.g., estimation logic), which may be any estimation algorithm that improves temperature predictions of the device at a given time such as, for example, a Moving Horizon Estimation algorithm, a Least Squares Method, and/or a Kalman Filter (e.g., the Kalman Filter 21 of FIG. 2). For example, the initial parameter determiner 128 may pre-compile parameters for the Kalman Filter similar to block 28 of FIG. 2.

At block 304 of FIG. 5, the estimation initializer 130 obtains initial temperature data from one or more measuring instruments 138. The estimation initializer 130 uses the initial temperature data to calculate an initial temperature state estimate for the estimation algorithm, as shown at block 306. For example, the estimation initializer 130 may initialize the Kalman Filter 21 of FIG. 2 by calculating an initial temperature state estimate (e.g., \hat{x}ₖ₋₁ of Equation 1, the initial filtered value calculated at block 30) similar to block 30 of FIG. 2.

At block 308 of FIG. 5, the predict measurement determiner 132 of the estimation engine 121 calculates a predict measurement value based on the estimation algorithm and the initial temperature state estimate calculated at block 306. For example, the predict measurement determiner 132 may calculate a predict measurement value (e.g., A\hat{x}ₖ₋₁ of Equation 1) similar to the firmware 20 (FIG. 2) calculating a predict measurement value at block 32 based on the initial filtered value calculated at block 30.

At block 310 of FIG. 5, the corrected measurement determiner 136 obtains data from one or more measuring instruments 138. (FIG. 3). For example, the corrected measurement determiner 136 may obtain current data (e.g., uₖ₋₁ of Equation 1) and temperature data (e.g., zₖ of Equation 2), which may be similar to block 34 of FIG. 2.

At block 312 of FIG. 5, the corrected measurement determiner 136 then calculates the temperature state estimate based on the data obtained at block 310, the estimation algorithm, and the predict measurement value. For example, the temperature state estimate may be the filtered value 18 (e.g., \hat{x}ₖ) that is calculated similar to block 36 of FIG. 2 by calculating the predicted temperature state estimate for time step k (e.g., \hat{x}ₖ⁻=A\hat{x}ₖ₋₁+Buₖ₋₁) and then the updated temperature state estimate (e.g., \hat{x}ₖ=\hat{x}ₓ⁻+K(zₖ−H\hat{x}ₖ⁻)) that corresponds to the filtered value 18.

At block 314 of FIG. 5, the fault identifier 122 determines whether the device 112 is at risk of overheating based on the temperature state estimate. If the fault identifier 122 determines the device 112 is at risk of overheating (e.g., block 314 returns a result of “YES”), the fault identifier 122 continues to block 316, and determines whether the device should shut down. If the fault identifier 122 determines the device should shut down (e.g., block 316 returns a result of “YES”), the fault identifier 122 continues to block 318 to trigger the device 112 to shut down, and the process 300 of FIG. 4 terminates. If the fault identifier 122 determines the device should not shut down (e.g., block 316 returns a result of “NO”), the fault identifier 122 continues to block 320 to trigger the device 112 to adjust operation, and then the fault identifier 122 continues to block 322.

If the fault identifier 122 determines the device 112 is not at risk of overheating (e.g., block 314 returns a result of “NO”), the fault identifier 122 continues to block 322. At block 322, the fault identifier 122 determines whether additional data is to be obtained. If the fault identifier 122 determines additional data is to be obtained (e.g., block 322 returns a result of “YES”), the predict measurement determiner 132 calculates a predict measurement value based on the previously calculated temperature state estimate at block 312 and the estimation algorithm. (block 324). The corrected measurement determiner 220 then returns to block 310. If the fault identifier 122 determines additional data is not to be obtained (e.g., block 322 returns a result of “NO”), the example process 300 of FIG. 5 terminates.

As mentioned above, the example process 300 of FIG. 5 may be implemented using machine readable instructions for execution by the temperature measurement controller 114 and/or the initial parameter determiner 128 of FIG. 3. One or more of the instructions may be embodied in software stored on one or more non-transitory machine readable mediums associated with the temperature measurement controller 114 and/or the initial parameter determiner 128, such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). Additionally or alternatively, one or more of the instructions may be embodied in firmware or dedicated hardware associated with the temperature measurement controller 114 and/or the initial parameter determiner 128. In some examples, the one or more instructions are downloaded to the temperature measurement controller 114 and/or the initial parameter determiner 128 from a software distribution platform. The temperature measurement controller 114 and/or the initial parameter determiner 128 may be distributed in different network locations (e.g., a multi-core processor in a single machine, multiple processors distributed across a server rack).

Although the example process 300 is described with reference to the flowchart illustrated in FIG. 5, many other methods of implementing the temperature measurement controller 114 and/or initial parameter determiner 128 may alternatively be used. The order of execution of the blocks may be changed, and/or some of the blocks described may be changed, eliminated, or combined. For example, blocks 302, 306, 308, 312, and/or 324 may be omitted if the estimation engine 121 does not implement a Kalman Filter 21 of FIG. 2.

In another example, the process 300 may include additional blocks if one or more parameters (e.g., Kalman gain (“K”) and matrices (“R”)) are updated while executing the estimation engine 121. Any or all of the blocks may be implemented by one or more hardware circuits (e.g., discrete and/or integrated analog and/or digital circuitry, an FPGA, an ASIC, a comparator, an operational-amplifier (op-amp), a logic circuit) structured to perform the corresponding operation without executing software or firmware.

Accordingly, a device assembly has one or more controllers to improve the performance of a device by more accurately monitoring whether the device is operating under abnormal conditions that present a risk (e.g., risk of fault, risk of damage, risk of overheating) to the device. A temperature measurement controller of the device assembly more accurately monitors whether a device is at risk of overheating, even if the temperature of the device is rapidly increasing, by performing one or more state estimation calculations based on temperature data of the device. The one or more state estimation calculations produce a temperature state estimate indicative of whether the device is at risk of overheating at a given time. The temperature state estimate allows the temperature measurement controller to more accurately trigger the device to shut down or adjust operation such that damage, failure, and/or malfunctions of the device caused by overheating is prevented. A fusion controller of the device assembly more effectively monitors whether the device is operating at abnormal conditions by merging data from one or more measuring instruments of the device, and performing any state estimation calculation to calculate any state estimate, such as to calculate a state of health estimate.

The phrase “communicatively coupled”, including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, the term non-transitory computer readable medium is defined to include any type of computer readable storage device and/or storage disk and to exclude propagating signals and to exclude transmission media. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

As used herein, singular references (e.g., “a”, “an”, “first”, “second”) do not exclude a plurality. The term “a” or “an” entity, as used herein, refers to one or more of that entity. The terms “a” (or “an”), “one or more”, and “at least one” can be used interchangeably herein. Further, although individually listed, a plurality of means, elements or method actions may be implemented by, e.g., a single device. Additionally, although individual features may be included in different examples or claims, these may possibly be combined, and the inclusion in different examples or claims does not imply that a combination of features is not feasible and/or advantageous.

Spatial and functional relationships between elements are described using various terms, including “coupled”. Unless a relationship between first and second elements is described explicitly described as being “direct” in the above disclosure, such relationship can be either a direct or an indirect relationship. A direct relationship is where no other intervening elements are present between the first and second elements, whereas an indirect relationship is where one or more intervening elements are present (either spatially or functionally) between the first and second elements.

Changes and modifications in the specifically described embodiments can be carried out without departing from the principles of the present disclosure which is intended to be limited only by the scope of the appended claims, as interpreted according to the principles of patent law including the doctrine of equivalents.

1. A device assembly comprising:
a device;
a measuring instrument coupled to said device, said measuring instrument configured to generate data; and
a controller communicatively coupled to said measuring instrument, said controller configured to perform a state estimation calculation based on the data to calculate a state estimate of said device for a time.

2. The device assembly of claim 1, wherein said controller is further configured to (i) determine whether said device is at risk at the time based on the state estimate, and (ii) generate a fault signal to trigger said device to modify operation in response to determining said device is at risk.

3. The device assembly of claim 2, wherein said device is configured to modify operation by shutting down.

4. The device assembly of claim 1, wherein said measuring instrument is a temperature measuring instrument, said device assembly further comprising a current measuring instrument coupled to said device, said current measuring instrument configured to generate current data, wherein said controller is configured to perform the state estimation calculation further based on the current data to calculate the state estimate of said device for the time.

5. The device assembly of claim 4, wherein said device is a motor, wherein said current measuring instrument is configured to generate the current data based on current input into said motor.

6. The device assembly of claim 1, wherein said device comprises a printed circuit board, wherein said measuring instrument is coupled to said printed circuit board of said device.

7. The device assembly of claim 1, wherein the time is a second time, wherein said measuring instrument is configured to generate the data at a first time before the second time.

8. The device assembly of claim 1, wherein said controller is further configured to determine whether said device is at risk at the time based on the state estimate by determining whether the state estimate exceeds a predetermined threshold state estimate, wherein said device is at risk when said controller determines the state estimate exceeds the threshold state estimate.

9. The device assembly of claim 1, wherein the data is second data generated after first data, wherein the state estimation calculation is a second state estimation calculation performed after a first state estimation calculation, wherein said controller is further configured to perform the first state estimation calculation based on the first data to calculate a first state estimate of said device for a first time, wherein said controller is configured to perform the second state estimation calculation further based on the first state estimate.

10. The device assembly of claim 1, wherein the time is a third time, wherein the state estimate is a third state estimate, wherein said controller is further configured to calculate a first state estimate of said device for a first time, wherein said controller is further configured to calculate a second state estimate of said device for a second time based on the first state estimate, wherein said controller is configured to perform the third state estimate further based on the second state estimate.

11. The device assembly of claim 1, wherein said controller is configured to perform the state estimation calculation by using a Kalman Filter.

12. The device assembly of claim 1, wherein the state estimate is a state of health estimate.

13. The device assembly of claim 1, wherein said measuring instrument is a first measuring instrument, wherein said data is first data, wherein said first measuring instrument is further configured to generate second data, said device assembly further comprising a second measuring instrument configured to generate third data, wherein said controller is further configured to merge the second and third data to produce merged data.

14. The device assembly of claim 13, wherein the state estimation calculation is a first state estimation calculation, wherein said controller is configured to merge the second and the third data by performing a second state estimation calculation using a Kalman Filter.

15. The device assembly of claim 13, wherein the state estimation calculation is a first state estimation calculation, wherein the state estimate is a first state estimate, wherein said controller is further configured to perform a second state estimation calculation based on the merged data.

16. The device assembly of claim 13, further comprising a system-in-package including said first measuring instrument, said second measuring instrument, and said controller.

17. The device assembly of claim 1, further comprising a system-in-package including said measuring instrument and said controller.

18. A device assembly comprising:
a device;
a plurality of measuring instruments configured to generate data;
a fusion controller communicatively coupled to said plurality of measuring instruments, wherein said fusion controller is configured to merge the data;
a temperature measurement controller communicatively coupled to said fusion controller, wherein said temperature measurement controller is configured to: (i) perform a state estimation calculation based on the merged data to calculate a state estimate of said device for a time, (ii) determine whether said device is at risk at the time based on the state estimate, and (iii) generate a fault signal in response to determining said device is at risk; and
a device controller configured to trigger said device to modify operation in response to determining said device is at risk.

19. The device assembly of claim 18, further comprising a system-in-package including said plurality of measuring instruments, said fusion controller, said temperature measurement controller, and said device controller.

20. A temperature measurement apparatus comprising:
an estimation engine to:
obtain temperature data from a temperature measuring instrument of a device,
perform a state estimation calculation based on the temperature data to calculate a state estimate of the device for a time; and
a fault identifier to:
determine whether the device is at risk of overheating at the time based on the state estimate, and
generate a fault signal to trigger the device to adjust operation in response to determining the device is at risk of overheating.
